(19) United States
(12) Patent Application Publication
(10) Pub. No.: US 2018/0339540 A1
(43) Pub. Date: Nov. 29, 2018

(54) FLORAL CARD

(71) Applicant: PROVIDE COMMERCE, INC., San Diego, CA (US)

(72) Inventors: Shannon BARNHARDT, San Diego, CA (US); Nikki KINOWSKI, San Diego, CA (US)

(21) Appl. No.: 15/604,915

(22) Filed: May 25, 2017

(51) Int. Cl. B42D 15/04; B65D 85/50; A01G 5/06; A01G 9/02; A01G 27/00; G09F 1/04; B42D 15/02

(52) U.S. Cl. CPC B42D 15/045; B65D 85/505; A01G 5/06; A01G 9/026; A01G 24/40; G09F 1/04; B42D 15/027; B65D 2203/00; A01G 27/00

(57) ABSTRACT

An example apparatus includes a greeting card portion having at least a back flap, a container housing coupled to the back flap of the greeting card portion, and at least one fluid container secured within the container housing, the fluid container including an opening to receive at least one stem of a flower therein, the fluid container further including a fluid to nourish the flower via the stem.

### BACKGROUND

Greeting cards are frequently exchanged or sent on various special occasions. For example, during the holiday season, families may send holiday greeting cards. Other such occasions may include, but are not limited to, birthdays, anniversaries, weddings or any of a variety of other occasions. Such greeting cards generally include text and/or graphics to express sentiments appropriate for the occasion.

### BRIEF DESCRIPTION OF THE DRAWINGS

For a more complete understanding of various examples, reference is now made to the following descriptions taken in connection with the accompanying drawings in which:

FIG. 1 illustrates a perspective view of an example floral card in an open position;

FIG. 2 illustrates the example floral card of FIG. 1 in a closed position;

FIG. 3 illustrates a perspective view of an example fluid container;

FIG. 4 illustrates a perspective view of another example fluid container;

FIG. 5 illustrates a perspective view of another example floral card in an open position;

FIG. 6 illustrates the example floral card of FIG. 5 in a closed position; and

FIG. 7 illustrates a perspective view of another example floral card in an open position.

### DETAILED DESCRIPTION

Various examples describe an apparatus providing live flowers and/or plants with a greeting card. Traditional greeting cards generally are limited to including text and/or graphics. As noted above, such cards are frequently exchanged on special occasions, such as birthdays, for example. In place of greeting cards, individuals may wish to send flowers or plants on the special occasions or as a special sentiment. Various examples described herein provide for a card that allows for the inclusion of live flowers and/or plants.

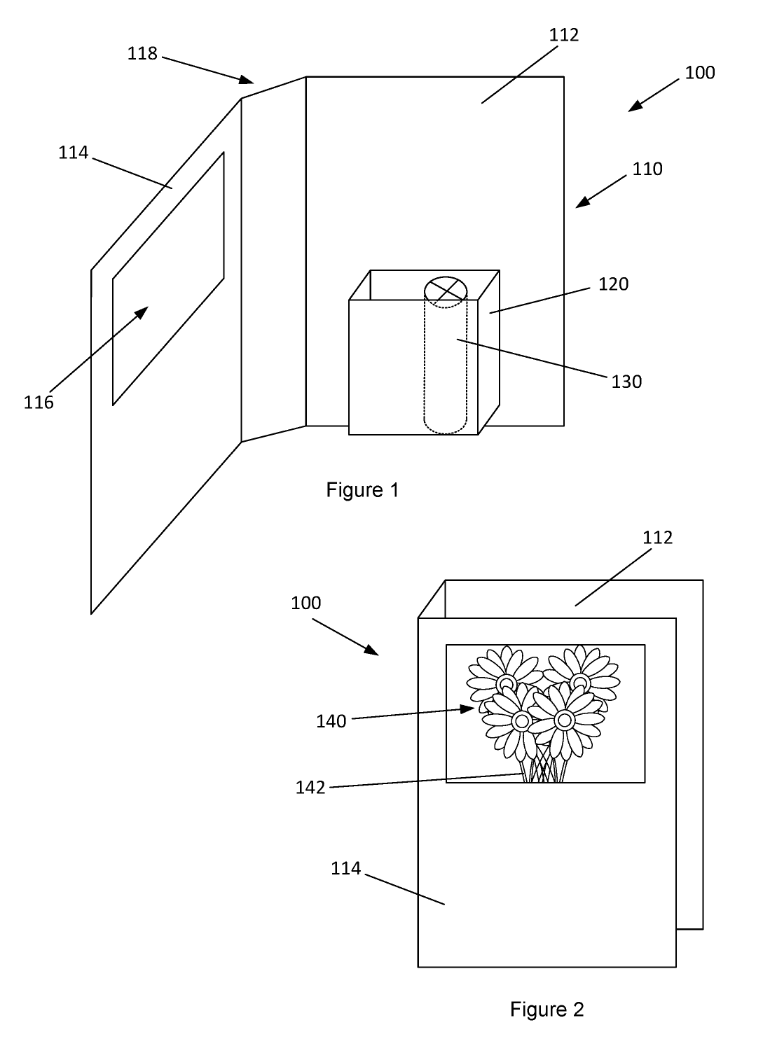

An example apparatus 100 is described below with reference to FIGS. 1 and 2. The example apparatus 100 forms a floral card which includes a greeting card with the ability to include live flowers or plants. The example apparatus 100 is formed with a greeting card portion 110. In various examples, the greeting card portion 110 may be formed of any of a variety of materials, such as paper, cardboard or plastic, for example. The greeting card portion 110 of the example apparatus 100 may be similar to conventional greeting cards and includes a back flap 112 and a front flap 114. The back lap 112 and the front flap 114 are hingedly coupled to allow the front flap 114 to rotate relative to the back flap 112. In the example of FIG. 1, the front flap 114 of the greeting card portion 110 includes a window 116. As illustrated in FIG. 2, in the closed position, the window 116 allows viewing of flowers 140 provided within the example apparatus 100, as described in greater detail below.

In the example apparatus 100 of FIGS. 1 and 2, the coupling of the back flap 112 and the front flap 114 includes a connecting portion 118. The connecting portion 118 is positioned between the back flap 112 and the front flap 114 and extends substantially the length of each flap 112, 114. The width of the connecting portion 118 is sufficient to allow a container housing 120 to reside between the back flap 112 and the front flap 114 when the greeting card portion 110 is in the closed position, as illustrated in FIG. 2.

As discussed above, the example apparatus of FIGS. 1 and 2 includes a container housing 120. The container housing 120 is coupled to the back flap 112 of the greeting card portion 110. In one example, the container housing 120 is affixed to the back flap 112. For example, the container housing 120 may be affixed to the back flap 112 with an adhesive. In other examples, the container housing 120 may be integrally formed with the back flap 112. For example, the container housing 120 may be formed of a cardboard or plastic material that is integrally formed as part of the back flap 112.

In the example illustrated in FIG. 1, the container housing 120 is formed to have a rectangular box shape. Various other examples may be provided with a container housing 120 having any other appropriate shape. The container housing 120 is provided with an opening on the top and a hollow interior to allow one or more objects to be placed therein. Various examples of the container housing 120 may be provided with a bottom to support objects therein.

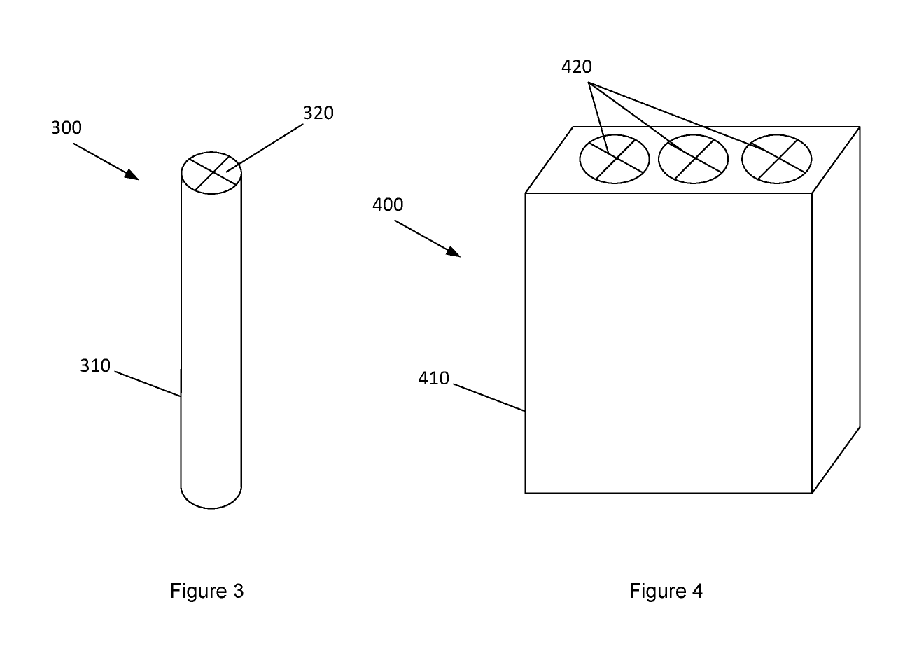

The container housing 120 is provided with at least one fluid container 130 secured therein. Various examples of the fluid container 130 are described below with reference to FIGS. 3 and 4. The fluid container 130 includes an opening on the top of the fluid container 130 to receive a stem 142 of a flower or a plant 140, as illustrated in FIG. 2. The container housing 120 may secure therein a single fluid container 130 or multiple fluid containers 130.

Each fluid container 130 is provided with a fluid to nourish the flower or plant via the stem inserted into the fluid container 130. In various examples, the fluid is a liquid, such as water. In some examples, various nutrients may be dissolved in the water to further the freshness or the life of the live flower or plant. In some examples, the fluid provided in the fluid container 130 may be a gel that may be absorbed by the stem of the flower or plant.

In this regard, by providing a fluid to nourish the live flowers and/or plants, the floral card may be delivered using regular mail and not require express delivery. The fluid allows the flowers and/or plants to survive and/or remain fresh, in each case, for a longer period.

In the example illustrated in FIG. 2, multiple flowers 140 with stems 142 are provided within the container housing 120. With the front flap 114 closed over the back flap 112, the flowers 140 are visible through the window 116 of the front flap 114.

Referring now to FIGS. 3 and 4, various examples of fluid containers are illustrated. Referring first to FIG. 3, a fluid tube 300 is illustrated. The example fluid tube 300 is provided with a tubular body 310 that may be sufficiently long to accommodate a portion of a stem of a plant or flower. Further, the tubular body 310 may be sized to store fluid that is sufficient to nourish a flower or plant for a desired length of time. In one example, the tubular body 310 is has a round cross-section with a diameter of approximately one inch and has a length of between 3 and 4 inches.

The example fluid tube 300 includes a self-sealing opening 320. The opening may be formed with flaps that may separate when a stem is inserted therein. The flaps may be formed of a plastic or a rubber material. With nothing inserted, as shown in FIG. 3, the flaps come together to close the opening 320. When a stem is inserted therein, the flaps may separate sufficiently to allow room for the stem while substantially preventing fluid in the tubular body 310 from leaking out. The tubular body 310 and the self-sealing opening 320 are sufficient to accommodate a single stem therein.

Referring now to FIG. 4, another example fluid container 400 is illustrated. The example fluid container 400 has a rectangular box body 410 to store a fluid therein. In one example, the body 410 is sized to fit into a container housing, such as the container housing 120 illustrated in FIG. 1. In other examples, the example fluid container 400 may have any of a variety of shapes, including a cylindrical tube. The example fluid container 400 includes a plurality of self-sealing openings 420, each opening 420 being to accommodate a single stem. Each self-sealing opening 420 of the example fluid container 400 may be similar to the self-sealing opening 320 described above with reference to FIG. 3. In the example illustrated in FIG. 4, the example fluid container 400 includes three self-sealing openings 420. In other examples, any other feasible number of openings is possible and is contemplated within the scope of the present disclosure.

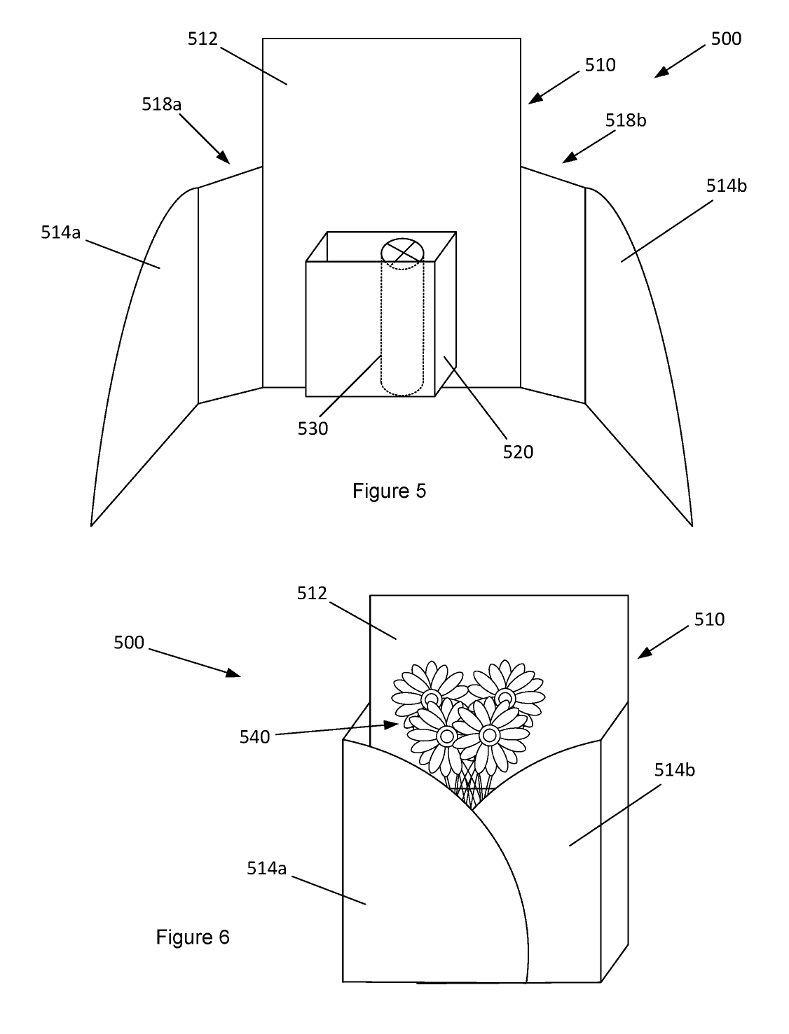

Referring now to FIGS. 5 and 6, another example floral card 500 is illustrated. FIG. 5 provides a perspective view of the example floral card 500 in an open position, and FIG. 6 illustrates the example floral card 500 of FIG. 5 in the closed position. The example floral card 500 is similar to the example apparatus 100 of FIGS. 1 and 2 and is formed with a greeting card portion 510. The greeting card portion 510 of the example floral card 500 includes a back flap 512 with two front flaps 514a, 514b. The back flap 512 is coupled to one front flap 514a,b on each side. Each front flap 514a,b is coupled to the back flap 512 through a connecting portion 5181,b.

The example floral card 500 of FIGS. 5 and 6 includes a container housing 520 coupled to the back flap 512 of the greeting card portion 510. As described above, the container housing 512 may be affixed to the back flap 512 or may be integrally formed with the back flap 512. The container housing 510 is provided with at least one fluid container 530 secured therein.

As illustrated in FIG. 6, in the closed position, the front flaps 514a,b overlap to cover at least the bottom portion of the back flap 512. Further, the overlapping front flaps 514a,b substantially cover the container housing 510, while allowing flowers 540 to be displayed. In this regard, the example floral card 500 is provided with front flaps 514a that are tapered (or rounded) to allow displaying of the flowers 540.

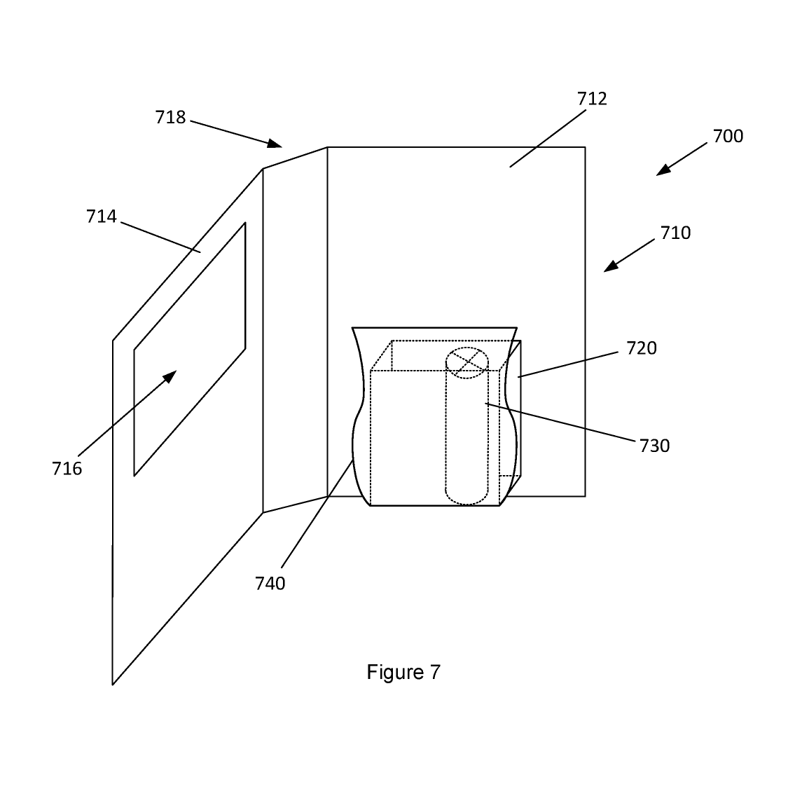

Referring now to FIG. 7, a perspective view of another example floral card 700 in an open position is illustrated. The example floral card 700 is similar to the example apparatus 100 described above with reference to FIGS. 1 and 2. In this regard, the example floral card 700 is formed with a greeting card portion 710 which includes a back flap 712 and a front flap 714. The front flap 714 of the greeting card portion 710 includes a window 716 that allows displaying of flowers therethrough. The back lap 712 and the front flap 714 are hingedly coupled through a connecting portion 718 to allow the front flap 714 to rotate relative to the back flap 712. The example floral card 700 includes a container housing 720 which is coupled to the back flap 712 of the greeting card portion 710. The container housing 720 is provided with at least one fluid container 730 secured therein.

The example floral card 700 of FIG. 7 includes a façade 740 coupled to the container housing 720. For example, in the example of FIG. 7, the façade 740 is positioned on a front surface of the container housing 720. In one example, the façade 740 may be a flat component that is affixed to the container housing 720 with, for example, an adhesive. The façade 740 may be shaped as a decorative container. In the example of FIG. 7, the façade 740 is formed as a vase. In other examples, the façade 740 may be formed as any of a variety of other shapes, such as an ice cream cone, a glass or a coffee mug. Of course, various other shapes are possible and are contemplated within the scope of the present disclosure.

Thus, various examples described herein allow for exchanging of greeting cards which include live flowers and/or plants. By providing the flowers and/or plants in a fluid, such as water, the floral cards may allow greater time for delivery and maintenance of freshness.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. An apparatus, comprising:
a greeting card portion having at least a back flap;
a container housing coupled to the back flap of the greeting card portion; and
at least one fluid container secured within the container housing, the fluid container including an opening to receive at least one stem of a flower or plant therein, the fluid container further including a fluid to nourish the flower or plant via the stem.

2. The apparatus of claim 1, wherein the greeting card portion further includes a front flap.

3. The apparatus of claim 2, wherein the front flap includes a window formed therein.

3. The apparatus of claim 2, wherein the back flap and the front flap are hingedly coupled via a connecting portion.

4. The apparatus of claim 1, wherein container housing is coupled to the back flap with an adhesive.

5. The apparatus of claim 1, wherein the container housing is integrally formed with the back flap.

6. The apparatus of claim 1, wherein the fluid container is a cylindrical tube with a self-sealing opening.

7. The apparatus of claim 1, wherein the fluid container is a rectangular box with a plurality of self-sealing openings, each self-sealing opening being to receive a single stem therein.

8. The apparatus of claim 1, further comprising:
a façade coupled to the container housing, the façade have a shape of a decorative container.

9. The apparatus of claim 8, wherein the shape of the façade is one of a vase, a cone, a glass or a coffee mug.

10. The apparatus of claim 1, wherein the fluid is a liquid.

11. The apparatus of claim 10, wherein the liquid is water.

12. The apparatus of claim 1, wherein the fluid is a gel.
